(19) United States
(12) Patent Application Publication
(10) Pub. No.: US 2021/0132708 A1
(43) Pub. Date: May 6, 2021

(54) MULTIFUNCTIONAL ELECTRONIC OPTICAL SYSTEM FOR TACTILE INTERACTION WITH SCREENS AND PROJECTORS AND COMPUTER-IMPLEMENTED METHOD FOR USE, TOGETHER WITH THE OPTICAL SYSTEM, IN INFORMATION PROCESSING FOR TEACHING AND LEARNING PROCESSES

(71) Applicant: ACCESO VIRTUAL - AULAS AMIGAS S.A.S., Antioquia (CO)

(72) Inventors: Diana Catalina Ayala Linares, Antioquia (CO); Milena Collazos Vargas, Antioquia (CO); Duban Andres Cardenas, Antioquia (CO); Juan David Cardona, Antioquia (CO); Fabian Andres Carmona Vargas, Antioquia (CO); Luz Adriana Gallego Madrid, Antioquia (CO); John Fredy Largo, Antioquia (CO); Cintya Viviana Laverde, Antioquia (CO); Manuel Lopera, Antioquia (CO); Juan Manuel Lopera Aristizabal, Antioquia (CO); Sergio Lopera Aristizabal, Antioquia (CO); Miguel Angel Lopez, Antioquia (CO); Alexis Munoz Carvajal, Antioquia (CO); Laura Orozco, Antioquia (CO); Camilo Patino Velez, Antioquia (CO); Fabian Esteban Ruiz, Antioquia (CO); Margarita Isabel Ruiz Velez, Antioquia (CO); Carlos Antonio Salcedo Bello, Antioquia (CO); Lina Maria Sanin Botero, Antioquia (CO); Edwin Alberto Sepulveda, Antioquia (CO); Alejandro Sepulveda Palacio, Antioquia (CO); Lina Uribe Medina, Antioquia (CO); Juan Carlos Valencia, Antioquia (CO); Jonathan Velasquez Quintero, Antioquia (CO); Camilo Zapata Ramirez, Antioquia (CO)

(21) Appl. No.: 17/257,504

(22) PCT Filed: Oct. 24, 2018
(86) PCT No.: PCT/CO2018/000023

§ 371 Date: Dec. 31, 2020

(30) Foreign Application Priority Data
Aug. 21, 2018 (CO) NC2018/0008735

(51) Int. Cl. G06F 3/0354; G06F 3/02; G06T 1/20; H04L 29/08; G09B 5/06

(52) U.S. Cl. CPC G06F 3/03543; G06F 3/03542; G06F 3/0227; H04W 84/12; H04L 67/141; G09B 5/06; G06F 2203/0337; G06T 1/20

(57) ABSTRACT

The present application satisfies the need to provide a teaching aid system that can connect to a projector, television or screen for interaction by means of a light pen. The electronic system comprises, among others elements, a fixed piece and a movable piece with an internal pivot shaft, the fixed part containing a wireless routing system. The fixed part has outlet ports for video, and Ethernet network and communication ports. The movable piece contains an image capture sensor, a sound sensor and an infrared radiation source sensor. The system also comprises internal components such as an integrated computer that is connected to a motherboard. The sound sensor and the infrared radiation source sensor are contained in the movable part and are connected by means of flexible wires to the motherboard or directly to the integrated computer. The motherboard and the integrated computer are connected together. The integrated computer has a single printed circuit board and is formed by an integrated circuit that contains, in the same encapsulation, a single- or multiple-core processor, a graphics processing unit and a dynamic random access memory. In addition, the integrated computer of the system has integrated circuits for the administration of ports and connectors and a non-volatile memory card. The infrared radiation source sensor is formed by a CMOS image sensor, an external infrared filter and a microchip that processes the signals from the image sensor. The system also includes a casing and a pen-type pointer that acts as a mouse for interacting with the computer.

### FIELD OF INVENTION

The present invention refers to a system or electronic device and the method of processing information for the presentation, exchange and processing of information in order to promote interaction in teaching-learning processes.

### BACKGROUND OF INVENTION

There are different products and methods known in the prior art for teaching aid with the use of sound, video and interconnection of stations for students with the main equipment of the teacher, among them we find:

The application with reference number CN201226190 entitled “TEACHING APPARATUS WITH OPTICAL PEN”, the aforementioned application refers to a teaching device with an optical pen, comprising a control table, an optical pen and at least one flat teaching object. The control table comprises a platform, a built-in speaker and an audio control circuit that is connected to the platform; the optical pen can be connected to the control table separately and has a speaker; and when the optical pen connects to the control table, the audio control circuit can control the built-in speaker and loudspeaker for different sounds. A teaching object with a plurality of detection marks in different positions is provided; when the teaching object is placed flat on the control table platform and its detection marks are triggered, the platform can send a sensing signal to the audio control circuit to drive that audio circuit to generate a sound signal corresponding to the detection marks and send the sound signal to the speaker and loudspeaker.

Despite being a product related to the object of our invention, the device disclosed in the aforementioned application presents substantial differences, among them, we find that the surface with which the interactive optical pen must have specific marks, does not use any surface. Interactions only generate sound effects, do not represent x-y coordinates that depending on the software can translate into geometric strokes or various commands that can cause sounds, videos, movements, selections etc., as varied as functions in a PC. It also does not have additional capabilities such as playing graphic content through a video output, nor can it connect with other devices, share content via WIFI, does not have sensors inside the machine that allow to grade tests, create an augmented reality. The system disclosed in the cited patent serves only the purpose of didactic interaction with printed educational material while the device of the present application is the one of access and interaction with digital content.

In that same respect, we find the invention patent application with reference number WO2015088173 and entitled “SMART DEVICE HAVING A TEACHING MATERIAL REPRODUCTION APP INSTALLED THEREIN, WHICH REPRODUCES INFORMATION OF BOOK-TYPE TEACHING MATERIAL USING CODE RECOGNITION PEN CAP ABLE OF PERFORMING BLUETOOTH COMMUNICATION” which discloses an intelligent device that has installed a reproduction application for teaching material, which reproduces information from a book-type teaching material, using a code recognition pen capable of performing Bluetooth communication and, using that code recognition pen capable of performing Bluetooth communications, where the teaching material playback application receives information from a particular learning area within the book-type teaching material when the code recognition pen capable of making Bluetooth communication contacts in the relevant learning area, provides the received information to the smart device that has the teaching material playback application installed, using Bluetooth communication, plays an image and a voice through the smart device that provides a widescreen.

As in the previous case, although here a product related to our invention is disclosed, in the aforementioned application the surface with which the optical pen interacts must have specific marks (or for example text), while in our invention the pen can use any surface, although for example it is blank or is a projection screen. In addition, in the aforementioned application the optical pen has sensors and a bluetooth communication module, in the present invention the subject is simpler, therefore, economical and the sensors are in the machine not in the pen. In addition, the device of the cited patent does not have an image sensor for grading tests or creating augmented reality and the purpose of the invention is to interact with a printed material and reproduce or complement it on the screens of the smart device(s) to which it connects. While the device disclosed by the invention is used to access, share and interact with digital content.

Finally, we find the application referenced with the number WO2015088173 and entitled “SMART DEVICE HAVING A TEACHING MATERIAL REPRODUCTION APP INSTALLED THEREIN, WHICH REPRODUCES INFORMATION OF BOOK-TYPE TEACHING MATERIAL USING CODE RECOGNITION PEN CAPABLE OF PERFORMING BLUETOOTH COMMUNICATION” which refers to a teaching system that has an optical pen and a machine (Smart device), said pen is separated from the machine and interacts with a flat surface and sends signals to the machine. It is a device that generates content graphically or with sound. The device shown is portable and the machine has a processor and an application (software) with various modes of use, and it further has wireless communication capability with other devices. As in all previous cases, it has substantial differences, such as in the aforementioned patent the surface with which the interactive optical pen must have specific marks (or for example text), our pen can use any surface, even if for example it is blank or is a projection screen. The optical pen in the same application has sensors and a bluetooth communication module, in the present invention is simpler, therefore, economical and the sensors are in the machine not in the pen. The mentioned patent does not describe having an image sensor for grading tests or creating augmented reality. As inferred, the purpose of the invention in the referenced patent is to interact with a printed material and reproduce or supplement it on the screens of the smart device(s) to which it connects. The device to be claimed here is for accessing, sharing and interacting with digital content.

For all of the above, there is a need for a device to help teaching with the elements and features already mentioned that can connect to a projector, TV or screen for interaction through an optical pen; use resources without the internet: function as a wireless access point; sharing the internet with other devices; create multiple-selection tests with a single response; and provide augmented reality as a support mechanism and synchronize the device information with a web platform.

### GENERAL DESCRIPTION OF THE INVENTION

The problem stated in the present application consists in the need to provide wireless access to educational content and interactive didactic mechanisms in scenarios with low technological infrastructure or in areas away from communication networks. A portable assistive device is required to be able to be taken from an area with an Internet connection to another area without access to the network. In addition, said assistant is required to be economically accessible and to integrate various functions into a single device to facilitate the teaching-learning process, such as the creation and grading of multi-choice tests with a single response; call to list, presentation and interaction tools through an optical pen; and function as a wireless access point for information exchange with other devices.

To solve this problem, the instant application proposes a multifunctional opto-electronic device consisting of an integrated computer for information processing, a non-volatile memory card, a wireless routing system for local area networks, an image capture sensor, a sound sensor, and an infrared radiation source sensor capable of tracking the movement of an external signaling accessory (optical pen). In the proposed configuration, all sensor elements are provided inside a moving substructure that allows you to adjust its inclination relative to a fixed substructure.

The computer-implemented method in conjunction with the hardware provides a method of synchronizing content in which the user logs in to a place with Internet access, selects from a list of available resources those that the user wants to download and index locally to be used later when there is no Internet access. During use the device is connected to a video display or projector using a cable or wireless video transmission system and the device is positioned in front of the image, adjusting the tilt so that the infrared sensor can capture the position of the optical pen when it slides over the area of the projected image, so that the pen emits an infrared light that is converted into two-dimensional position information and transmitted to the integrated computer for interpretation and generating mouse events.

Within the aforementioned method when the user logs in selects a study group and evaluation area and deploys a grading module from which the image capture sensor is used to digitize the selected response information in a printed format that is shown to the device so that the evaluation grade corresponding to the marked responses is calculated using an image processing algorithm.

The invention proposed here will be defined and explained in more detail below.

### DESCRIPTION OF THE FIGURES

To complement the accompanying description and in order to help a better understanding of the characteristics of the invention, in accordance with a preferred example of practical implementation of the same, a group of figures is accompanied as an integral part of the description, in which, for illustrative and non-limiting purposes, the following has been represented:

FIG. 1 shows a perspective view of an implementation example of the opto-electronic device proposed in the application showing its exterior appearance in the open (A) and closed (B) state and also showing the optical pen (C) that is part of the invention.

FIG. 2 shows the input and output ports of the opto-electronic device used for connection to various external devices. This figure also illustrates the position of the pivot axis on which the moving part rotates relative to the fixed part.

FIG. 3 is an explosive view that allows seeing all the components that form the opto-electronic device, both of the mobile part, where all the sensors (image capture, infrared light sensor, sound sensor) are located, as well as the fixed part inside which are among others the main electronic board and the integrated computer, which are assembled with each other by a rigid multi-contact connection. On the main electronic board are, among others, the router or wireless routing system for local area networks and the user interaction button.

FIG. 4 corresponds to the graphical representation of the touch projection stage.

FIG. 5 shows the sequence diagram of the touch projection stage.

FIG. 6 shows the component diagram of the touch projection stage.

FIG. 7 shows the flowchart of the keyboard and mouse recognition stage.

FIG. 8 shows the sequence diagram of the keyboard and mouse recognition stage.

FIG. 9 shows the component diagram of the keyboard and mouse recognition stage.

FIG. 10 shows the flowchart of the modular upgrade stage.

FIG. 11 shows the sequence diagram of the modular upgrade stage.

FIG. 12 shows the component diagram of the modular upgrade stage.

FIG. 13 shows the flowchart of the stage of using resources without the internet.

FIG. 14 shows the sequence diagram of the stage of using resources without the internet.

FIG. 15 shows the component diagram of the stage of using resources without the internet.

FIG. 16 shows the flowchart of the attendance and grading stages.

FIG. 17 shows the sequence diagram of the attendance and grading stages.

FIG. 18 shows the component diagram of the attendance and grading stages.

FIG. 19 shows the flowchart of the augmented reality generation stage.

FIG. 20 shows the sequence diagram of the augmented reality generation stage.

FIG. 21 shows the component diagram of the augmented reality generation stage.

### DETAILED DESCRIPTION OF THE INVENTION

The hardware components of our system are generally processors, memory, video output, usb ports, wireless router or network port, memory, power source, wifi antenna, circuit board cooling system.

The electronic system for touch interaction with screens or projectors has a router device and an antenna that allows the simultaneous connection between 2 or more machines or computers, to the information stored in the memory of the main equipment. The device has a custom configuration of a router module that allows wireless interconnection of a set of electronic devices (IP machines) using subnetworks, that is, that can send or route data packets from one network to another, the connection capacity depends on the preconfigured hardware specifications.

In addition, the system has an optical pen consisting of a peripheral whose function is equivalent to that of a “Mouse” or computer mouse. The pen emits infrared light at the tip when making contact with a rigid surface, in order to achieve interaction with the system and supply the signal input using the IR sensor of the device, so that the processing is performed that allows to convert the detected signal into a position equivalent to cartesian coordinates in the plane, allowing in conjunction with the processing, to convert any projection surface into a touch interface.

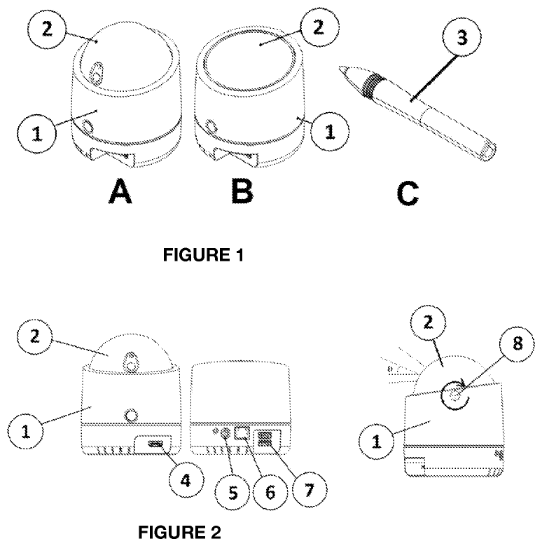

Next, the device will be described in detail. In view of FIGS. 1 to 3, the multifunctional opto-electronic device is characterized by having a fixed section or part (1) and a moving section or part (2), where the fixed part includes inside: a wireless routing system for (16) that by means of an antenna (21) creates a local area network, connects to an external wireless network or allow other devices to connect to an integrated computer (14) that has output video ports (4) and Ethernet network (6) ports and universal serial bus communication ports (7); and the moving part integrates inside an image capture sensor (CMOS-type 12), a sound sensor (13) and an infrared radiation source sensor (9) capable of tracking the movement of an external signaling accessory (3).

The moving part of the opto-electronic device has an internal pivoting axis (8) that allows to adjust the inclination of the moving part relative to the fixed part in at least a degree of freedom to improve the viewing angle of the sensors. The moving part can preferably be implemented in the form of a semisphere to be safely stored inside the fixed part (1) for transport purposes.

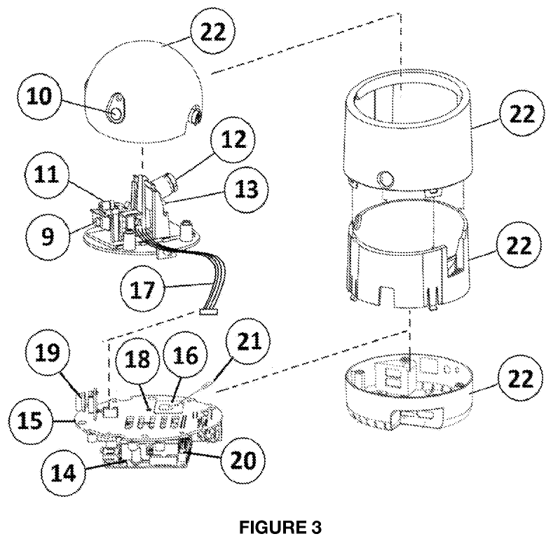

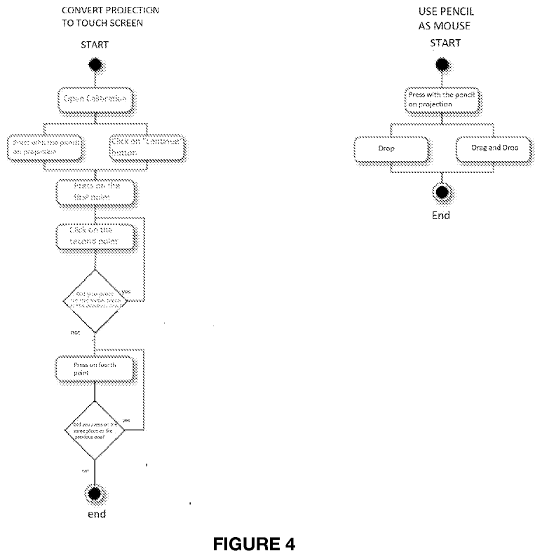

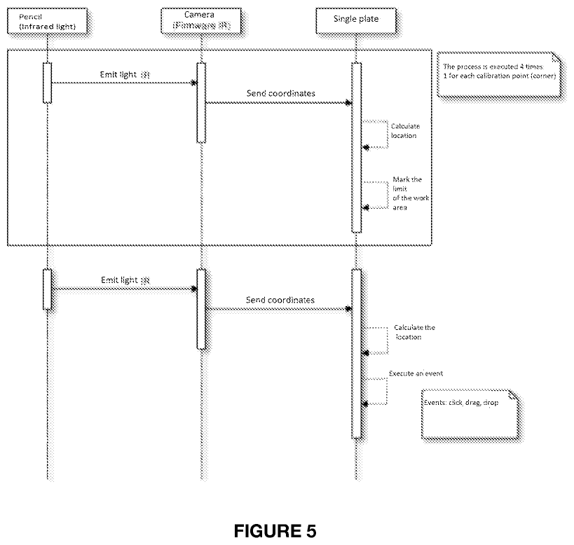

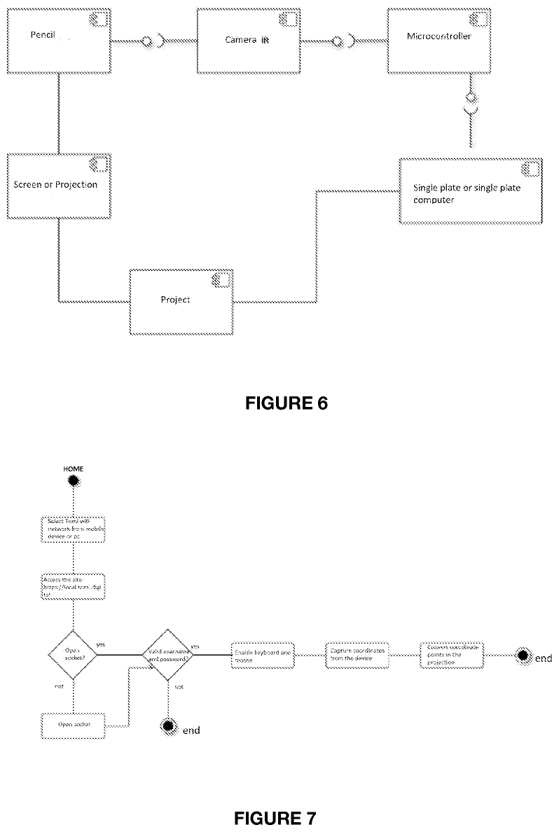

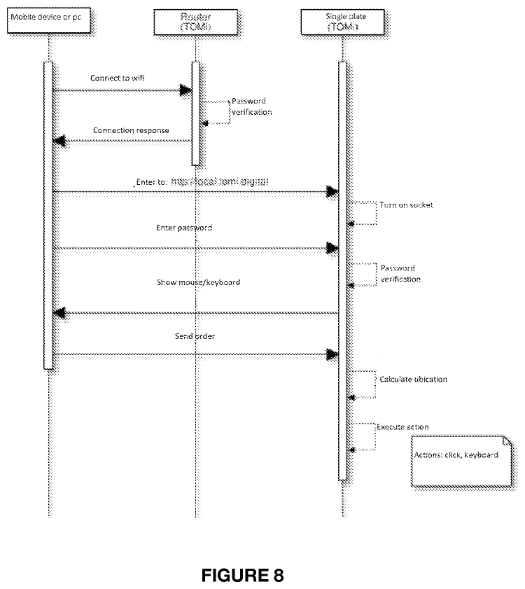

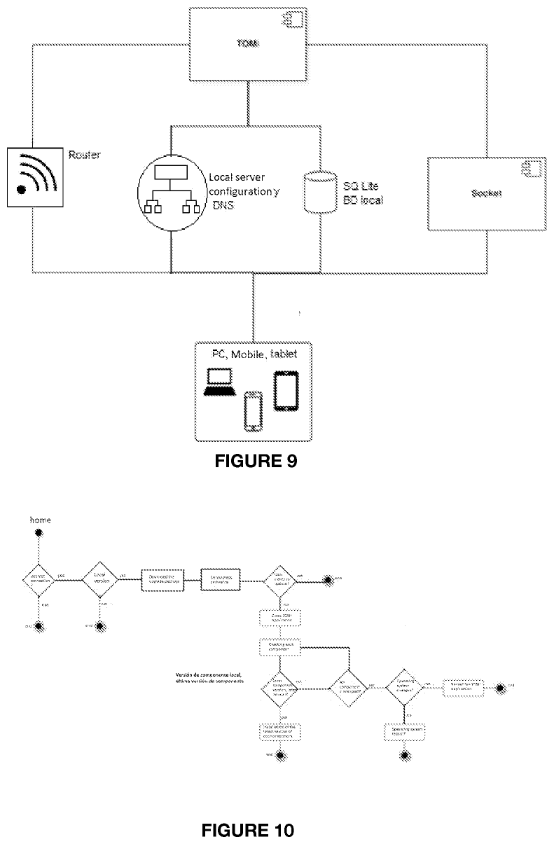

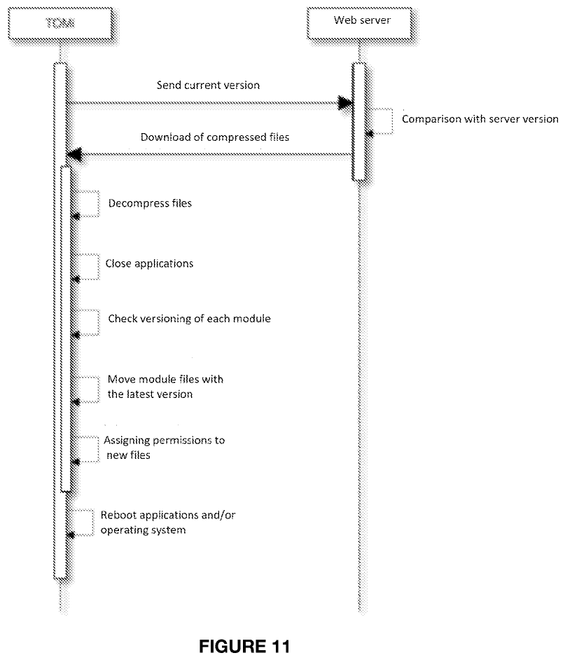

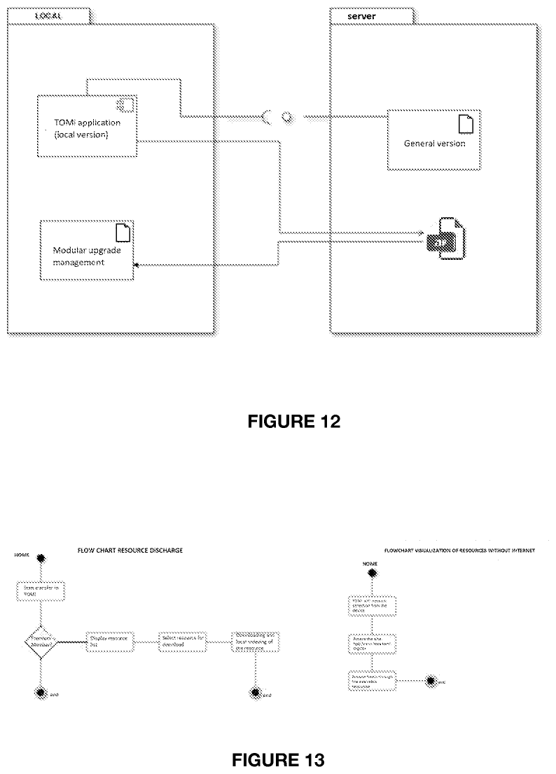

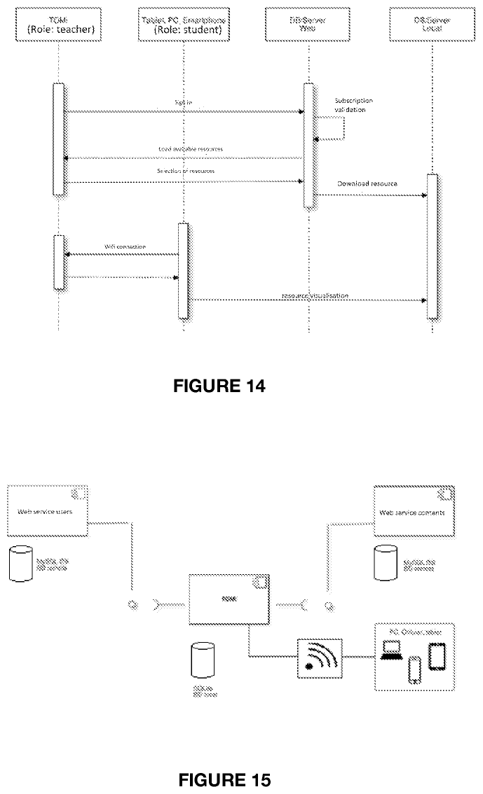

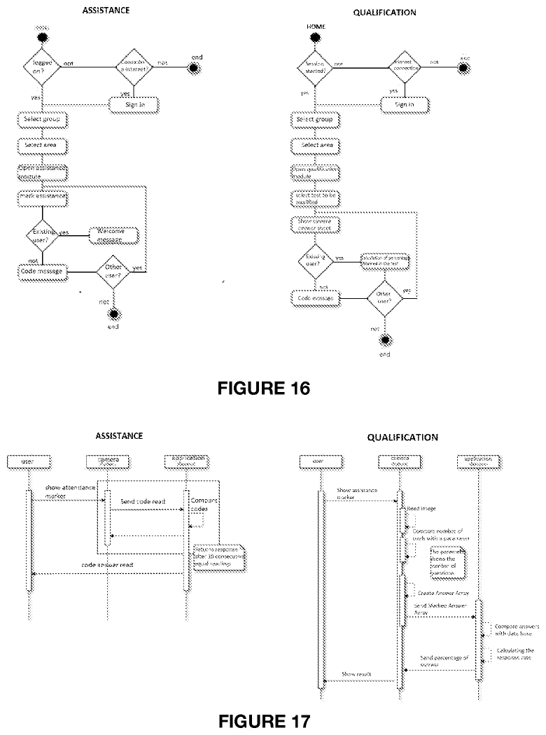

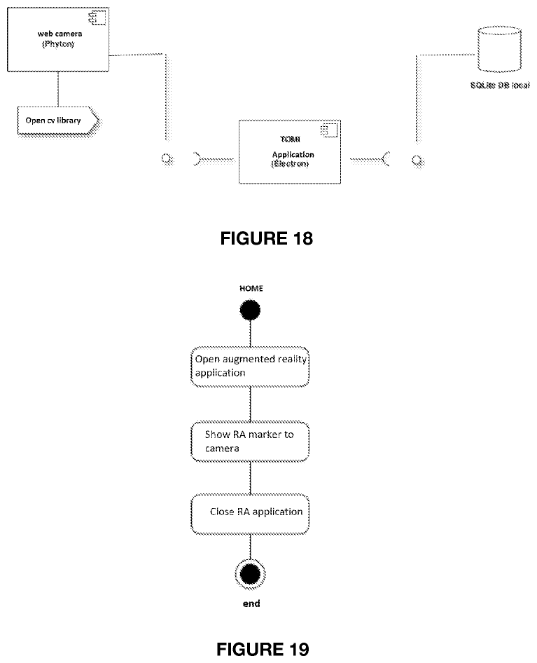

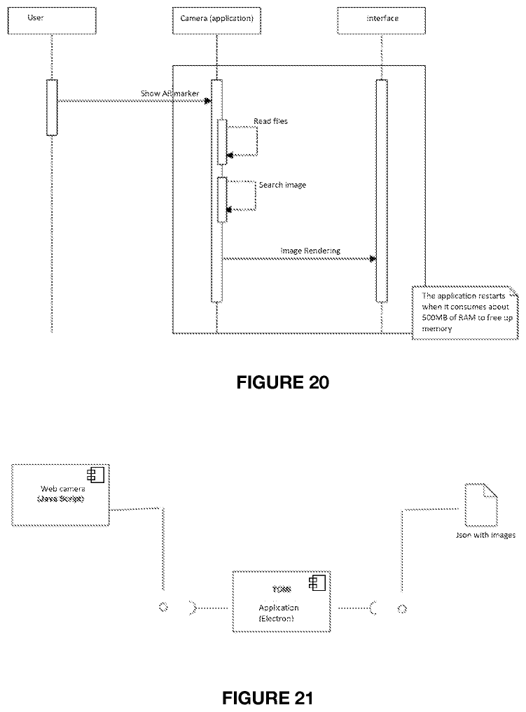

The exploded view of FIG. 3 shows the internal components of the opto-electronic device, where the integrated computer (14) connects to a main board (15) containing the wireless routing system for local area networks (16) and at least one button (19) for user interaction. Sensors housed in the mobile part are connected by flexible cables (17), either to the main board or directly to the integrated computer. The main board (15) also has light-emitting diodes (18) that serve as visual function indicators.

The connection between the main board (15) and the integrated computer (14) is made for example by a rigid multi-contact connection (20) that in addition to allowing the transfer of data and control signals between the circuits, also shares the power supply and serves as mechanical support to the assembly.

The integrated computer used (14) is of the type characterized by being manufactured on a single printed circuit board of a credit card size and consists of an integrated circuit that contains in the same encapsulation a processor of one or multiple cores, processor has one or more processors, specifically the device has 2 processors each of 4 cores, the first four operate at a clock frequency of 2.0 GHz and the other four operate at a clock frequency of 1.4 GHz, a graphics processing unit, and dynamic random access memory. Additionally, the computer has integrated circuits for port management and connectors for video signal output (4) and serial communication ports (7) and a non-volatile memory card.

The infrared radiation source sensor (9) consists of a CMOS image sensor, an external infrared filter (10), and a microchip that processes the image sensor signals and calculates the two-dimensional position coordinates of detected infrared radiation sources and transmits those coordinates to the integrated computer via a serial communication port.

All internal components are protected by a plastic housing (22) composed of several parts that are assembled together by means of flexible fittings minimizing the use of screws or additional fasteners.

The accessory (3) is a pencil-like pointer that has at the end an infrared light source, for example, a light-emitting diode, whose emission peak is between 700 nm and 10000 nm, which can be activated by a mechanical switch on contact with a surface or manually by pressing a button. This optical pen serves as a point source of infrared light that when interacting with the sensor (9) acts as a mouse to interact with the computer. It has a beveled tip with a low friction material, resistant to direct impacts on its tip, anatomical design, with a hole for a clamping element, a body in high-impact ABS, pointer in white acetal and rechargeable. This pen consists of rechargeable or non-rechargeable batteries, plastic pointer, a circuit, positive and negative terminal, a spring (6), female “Jack” for battery recharging, fasteners, and a base housing.

Finally, on top of the device, a mechanical turning system brake could be provided, additionally, towards the inside of the fixed and moving parts (1, 2) the element is assembled by means of inserts and have an internal support structure.

Computer-Implemented Method for Applying in Conjunction with a Hardware Device for Touch Interaction with Screens or Projectors, and Information Processing for Teaching-Learning Processes

The computer-implemented method for applying in conjunction with a hardware device for touch interaction with screens or projectors, and information processing for teaching-learning processes comprising the following features and stages:

The stages are selectively carried out, individually, combined and in any order.

Stage a. Touch projection. Connect to a projector, TV or display, for interaction via an optical pen of the electronic device for interaction and touch screen conversion.
Convert projection to touchscreen via the optical pen
Emit an IR infrared light from the optical pen to the camera's “firmware” microprocessor
Send the coordinates of the single board by the camera
Run 4 times for each calibration point (corner): Calculate the location for the single plate; mark the limit of the work area by the single board.
Emit an IR infrared light from the optical pen to the camera's “firmware” microprocessor
Send the coordinates to the single board by the camera's “firmware” microprocessor
Calculate by the single plate the location of the light source
Run an event (click, drag, drop) by the single card

Stage b. Keyboard and mouse recognition. Converting an external device as a wireless mouse or keyboard to the device eliminating the need for a physical keyboard or mouse
Connect the mobile device or PC to a Wifi network via the router of the electronic device for touch interaction; verify the password and send the connection response to the mobile device or PC by the device router.
Enter by the mobile device or PC the email address of the electronic device for touch interaction to the single board of that device. Turn on socket
Enter by the mobile device or PC the password to the electronic device for touch interaction to the single board of that device. Verify the password.
Display by the electronic device for touch interaction the keyboard and mouse to the mobile device or PC
Send by the mobile device or PC an order to the single board of the electronic device for touch interaction. Calculate location and execute action (click, keyboard)

Stage c. Modular update
Send by the electronic device for touch interaction the current version to the web server; compare with the version contained on the server.
Download by electronic device for touch interaction the compressed files sent by the web server.
By the electronic device for touch interaction decompress files, close applications, check versions of each module, move module files with latest version, assign permissions to new files, restart applications and/or operating system.

Stage d. Use resources without the internet: download and access a repository of educational content and store them for later access without having to be connected to the internet:
Start session with the device
By the electronic device for touch interaction: connect to a DB web server, validate subscription and load available resources
By the electronic device for touch interaction: select the available resources, connect to a DB database web server and download resources to local DB server
By the PC, smartphone and tablets connect to a Wifi network through the electronic device for touch interaction and view resources from the local DB server of the interaction device.

Stage e. Data synchronization.
Start session by the operator by connecting to the test web server
Verify by the electronic device for touch interaction the changes to be synchronized by sending them to the resource web server
Send by the resource web server the updated data to the electronic device for touch interaction
Verify by the electronic device for touch interaction the data to be synchronized to the test web server
Send updated data to the electronic device for touch interaction by the test web server
Verify by the electronic device for touch interaction the changes to be synchronized by sending them to the group web server
Send the updated data to the device by the group web server.

Stage f. The electronic device for touch interaction, functions as a wireless access point that allows to connect other devices to access and use the resources or contents that are downloaded;

Stage g. Create multiple-selection tests with single response;

Stage h. Register class attendance by reading a code that is shown to the camera of the electronic device for touch interaction:
Show by the operator the attendance marker to the camera
Send by the camera a code read to the application that compares the code and returns the response after 10 consecutive equal readings.

Stage i. Randomly inviting students to participate in class activities, a random number is generated.

Stage j. Award badges to students based on their work from knowledge, skills, values and attitudes;

Stage k. Review, grade, and submit reports that can be read by the device's camera, and automatically show the percentage achieved in the test, as well as generating a group report with each student's total grades, badges, and class absences:
Show by the operator an attendance marker to the camera
Read the image by the camera.
Compare the number of ovals by the camera with a parameter that indicates the number of questions the answer sheet has
Create by the camera the arrangement of answers
Send by the camera the arrangement of responses to the application
Compare responses with the database by the application
Calculate by the application the percentage of correct answers and send it to the camera
Show the result to the operator by the camera

Stage l. Generate by the electronic device for touch interaction an augmented reality as a support mechanism that allows the teacher to teach or reinforce knowledge exploratorily through the visualization of 3D objects;
Show the marker by the user to the camera of the electronic device for touch interaction.
Read files and search for image by the camera of the electronic device for touch interaction.
Render the image and send to the interface by the camera of the electronic device for touch interaction
Restart the application when using about 500 MB of RAM to free up memory.

Stage m. A module of synchronization of device information with a web platform, so that students and tutors can visualize in a log the results of their tests and badges received.

As could be evidenced in the description of the invention, the device or system of the present invention has a very important functionality and is the infinite work area, which consists of a functionality of the software that allows the canvas or work area to have no limits on its dimensions, which allows the teacher and students to append the space they require on the screen and in this way save in a single file all the information that they generate in the pedagogical process.

The electronic system for touch interaction with screens or projectors of our application comprises several modules, among them we have: a module that, connected to a projector, TV or screen, allows interaction through an optical pen; a module that allows you to download and access a repository of educational content and store them for later access without having to be connected to the internet; a module for the device to function as a wireless access point that allows other devices to be connected to access and use downloaded resources or content; a module to share the internet with other devices; a module for creating multi-choice tests with a single response; a module for registering ciase attendance by reading a code that is showed to the device's camera; a module that allows students to randomly be invited to participate in class activities; a module to award badges to students based on their work from knowledge, skills, values and attitudes; a module with a rating format and reports that can be read by the device camera, and automatically shows the percentage achieved in the test, in addition generates a group report with the total notes, badges and class absences of each student; an augmented reality module as a support mechanism that allows the teacher to teach or reinforce knowledge exploratorily through the visualization of 3D objects; and a module to synchronize the device information with a web platform, so that students and tutors can visualize on a blog the results of their tests and badges received.

In summary, what is achieved with the electronic device for touch interaction with screens or projectors and its software is:
Make the device work without internet, to store the information and then synchronize.
Allow the teacher to download content and the students to enter without the internet (Browse without internet).
Allows through a web platform (internal), that from any other device (tablet, cell phone, computer), such device can be used as a keyboard and mouse of the device using the Wifi network.
Allows you to remotely update all device modules.
Convert any projection surface into a touch screen.
A data processing of an IR sensor to convert the data received from the camera, into on-screen coordinates to be used as a mouse.
Adequate response speed in digital image processing for list call and grading.
An outsourcing mechanism of the internal computer ports.

1-3. (canceled)

4. An electronic device for tactile interaction with screens or projectors comprising:
a fixed part (1) enclosing a wireless routing system (16) with an antenna (21) forming a local area network, and including at least one button (19) for user interaction, output video ports (4), Ethernet network ports (6) and universal serial bus communication ports (7), wherein said wireless routing system (16) connects to an external wireless network or makes other devices connect to an integrated computer (14) that is provided inside said fixed part (1) and is connected to a main board (15) containing the wireless routing system (16), said main board (15) having light-emitting diodes (18) serving as visual indicators of operation, wherein the integrated computer (14) includes a non-volatile memory card and has integrated circuits for port management and connectors for video signal output (4), said integrated computer (14) comprises a single printed circuit board including an integrated circuit encapsulating a processor of at least one core, a graphics processing unit and a dynamic random-access memory;
a moving part (2) integrating and enclosing within an image capture sensor, a sound sensor (13) and an infrared radiation source sensor (9) that tracks movement of an external signaling accessory (3), said moving part (2) having an internal pivot axis (8) to adjust the inclination of the moving part (2) relative to the fixed part (1) and the viewing angle of the image capture sensor, the sound sensor (13) and the infrared radiation source sensor (9), wherein the moving part (2) and the fixed part (1) comprise a plastic housing (22) consisting of plural parts assembled together by flexible sockets;
the sound sensor (13) and the infrared source sensor (9) being connected either to the main board (15) or directly to the integrated computer (14) by flexible cables (17), wherein said infrared radiation source sensor (9) comprises a CMOS image sensor, an external infrared filter (10) and a microchip that processes the image sensor signals and calculates two-dimensional position coordinates of detected infrared radiation sources and transmits said two-dimensional position coordinates to the integrated computer (14) via a serial communication port; and
a pencil type pointer (3) provided with an infrared light source at one end configured to interact with the infrared source sensor (9) so that the pencil type pointer (3) act as a mouse to interact with the integrated computer (14).

5. The electronic device for tactile interaction according to claim 4, wherein said internal pivot axis (8) adjusts the inclination of the moving part (2) with respect to the fixed part (1) in at least one degree of freedom.

6. A computer-Implemented method for application in conjunction with a hardware device for tactile interaction with screens or projectors, and for information processing for teaching-learning processes, said method comprising:
creating a tactile projection environment by connecting an electronic device to a projector, television or screen, and providing an optical pen to interact with said electronic device in order to convert an image displayed by said projector, television or screen into a touch screen, where a camera provided on said electronic device captures a light emitted by said optical pen and a microprocessor calculates two-dimensional position coordinates of said light emitted and transmits said two-dimensional position coordinates to an integrated computer that calculates the location of the source of light in relation to said displayed image and executes an event based on said location, wherein limits of a working area are calibrated by capturing said light emitted four times on corners of said displayed image;
recognizing and associating an external keyboard and mouse to said electronic device by connecting a mobile device or PC to a WIFI network through a router provided on said electronic device and authenticating said mobile device or PC into said WIFI network, displaying on said mobile device or PC said keyboard and said mouse, wherein said mobile device or PC sends an instruction to said electronic device so that an integrated computer calculates a location and executes an action;
updating modules of said electronic device by sending a current version of said modules to a web server, comparing said current version with a version contained on said web server and downloading compressed files sent by the web server, wherein said compressed files are decompressed, applications are closed so that a version of each module is verified, module files are moved, and new files are assigned permissions, restart at least one of the applications or an operating system.
using resources without Internet access by downloading and accessing a repository of educational content and storing said educational content for later access without the need to be connected to the Internet;
synchronizing data by initiating a session when a user connects to a test web server, said electronic device sending changes to be synchronized to a resources web server and receiving from said resources web server updated data, verifying by said electronic device data to be synchronized to said test web server, receiving at the electronic device the updated data sent by said test web server, sending the changes to be synchronized to a group web server which sends the updated data to the electronic device;
providing said electronic device as a wireless access point to allow other devices to access and use resources or content downloaded into said electronic device;
creating at the electronic device multiple-choice tests having a single answer;
registering class attendance by reading a code shown to the camera of said electronic device, wherein a read code is sent to an application that compares said code and provides a response after ten consecutive equal readings;
randomly inviting students to participate in class activities by generating a random number;
providing badges to students based on their work from knowledge, skills, values and attitudes;
reviewing, grading and providing reports that are read by the electronic device's camera, automatically showing a grading percentage achieved on the test and generating a group report with total grades, badges and absences of each student;
generating by the electronic device an augmented reality environment as a support mechanism that allows a teacher to teach or reinforce knowledge in an exploratory way through visualization of 3D objects, wherein the user shows a marker to the camera of the device which read files and search for images rendering an image and sending the image to an interface; and
synchronizing the electronic device information with a web platform and displaying in a log results of tests and badges received.

7. The computer-Implemented method according to claim 6, wherein the steps are selectively carried out either individually or combined and in any order.
